(19) United States
(12) Patent Application Publication
(10) Pub. No.: US 2025/0121976 A1
(43) Pub. Date: Apr. 17, 2025

(54) LABEL ROLL COOLING COVER

(71) Applicant: Hurst International, LLC, Chatsworth, CA (US)

(72) Inventors: Ari Lichtenberg, Chatsworth, CA (US); Ryan Hernandez, Sun Valley, CA (US)

(21) Appl. No.: 18/909,077

(22) Filed: Oct. 8, 2024

Related U.S. Application Data
(60) Provisional application No. 63/590,175, filed on Oct. 13, 2023.

(51) Int. Cl. B65C 9/38

(52) U.S. Cl. CPC B65C 9/38

(57) ABSTRACT

A cooling cover for a label roll in a label dispensing system is provided. The cooling cover operates as a label roll holder and is installed on the label dispending machine. The cover includes two sides that encase the label roll and allow the same to freely rotate therein. A cool air input connection feeds air manifolds and cooling air channels extending throughout the sides making up the cover. One or more adjustable exhaust openings are provided on the edges of the cover to allow for adjustment of the temperature within the cover.

### BACKGROUND

### Technical Field

The present invention relates to label application systems. More particularly, it relates to a cooling cover for a roll of adhesive labels that are dispensed by a label application system onto products and/or produce.

### Description of the Prior Art

Label applicator systems/machines often operate in warm environments, both due to the heat generated by the production equipment used to process the products, the size of the room where the equipment is operating, and the ambient air of the room/facility.

This operation in a warm environment can have a negative impact on the adhesive material on the specific label roll, particularly when more aggressive and softer adhesives are used. When the temperature of the operating environment of the label applicator system, and thus the label roll, reaches 70+ degrees F., the more aggressive and softer adhesives can ooze out from the edges of the labels, causing many different problems during label application.

It is therefore an aspect of the present invention to address and solve the above-mentioned problem associated with the overheating of the label roll during use.

### SUMMARY

This and other aspects of the invention are achieved in accordance with an implementation where the label roll cooling cover includes a first side and a second side. The first and second sides are configured to fit around a label roll while installed on a label application system. A plurality of air channels are disposed on an inside surface of at least one of the first side and second side, and a cool air input is provided on at least one of the first side or second side, the cool air input in communication with the plurality of air channels. In addition, at least one exhaust air output is positioned at an edge of at least one of the first side and second side.

In accordance with another implementation, the label roll cooling cover includes a first side and a second side configured to fit around a label roll. A plurality of air channels are disposed on an inside surface of at least one of the first side and second side, and a connection mechanism connects the first side to the second side with the label roll disposed therein. The connection mechanism includes a core holder and a free rotating adapter positioned over the core holder that enables the label roll with cooling cover to be attached to a label dispensing machine.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a plan view of an exemplary label applicator machine showing the label cooling cover according to an embodiment;

FIG. 2 is another plan of an exemplary label applicator machine showing the label cooling cover according to an embodiment;

FIGS. 3A-3F show the label cooling cover according to an embodiment;

FIG. 4A shows an exploded perspective view of the label cooling cover according to an embodiment; and

FIG. 4B shows a partial cross-sectional view of the label cooling cover according to an embodiment.

### DETAILED DESCRIPTION

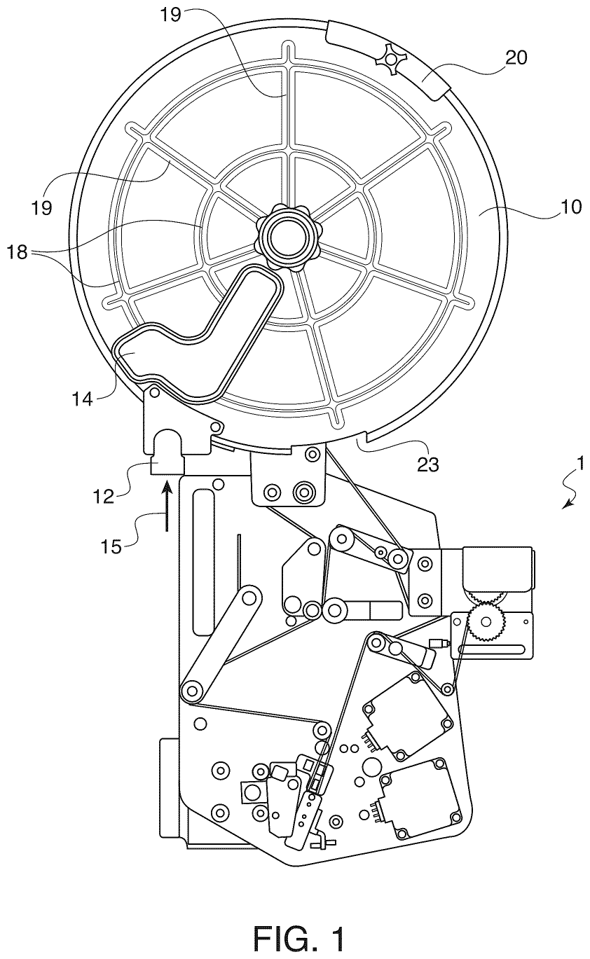

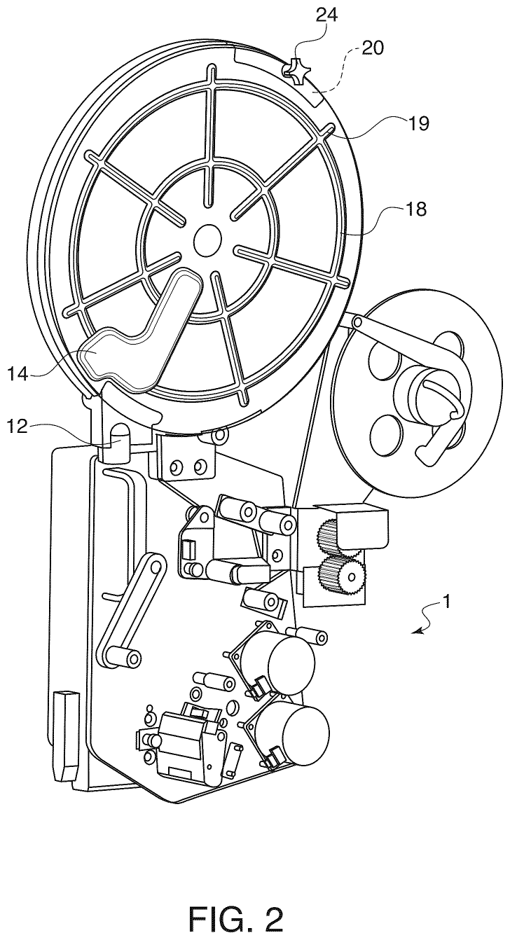

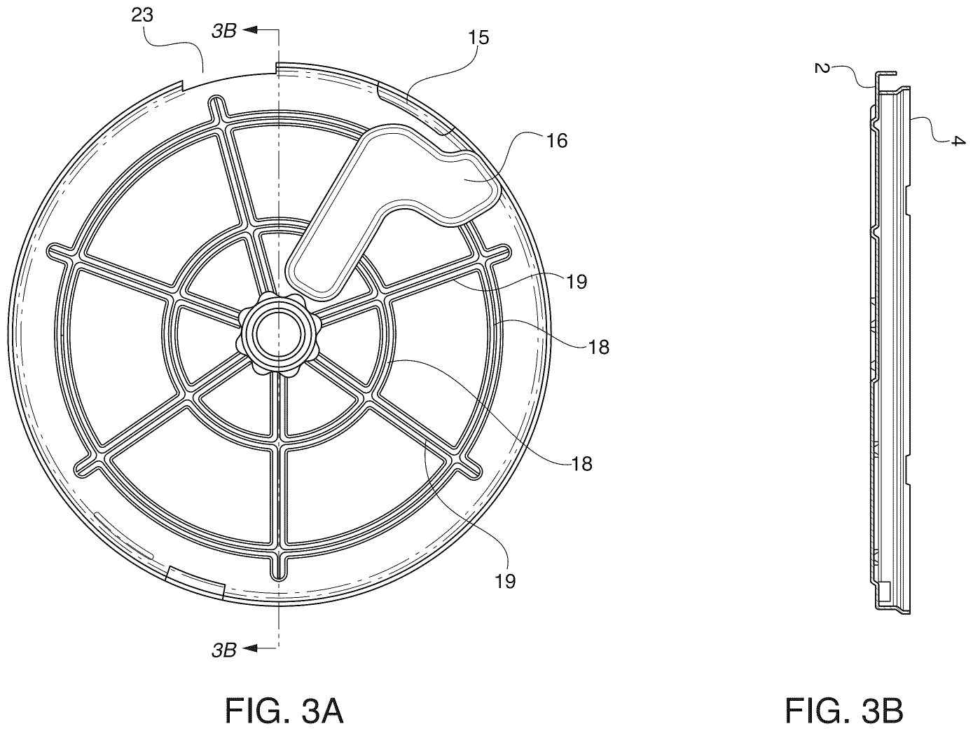

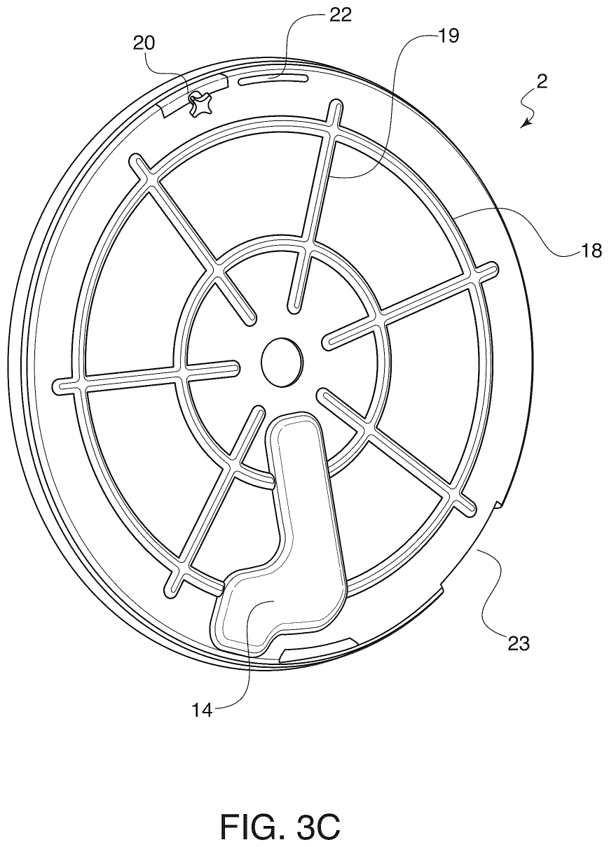

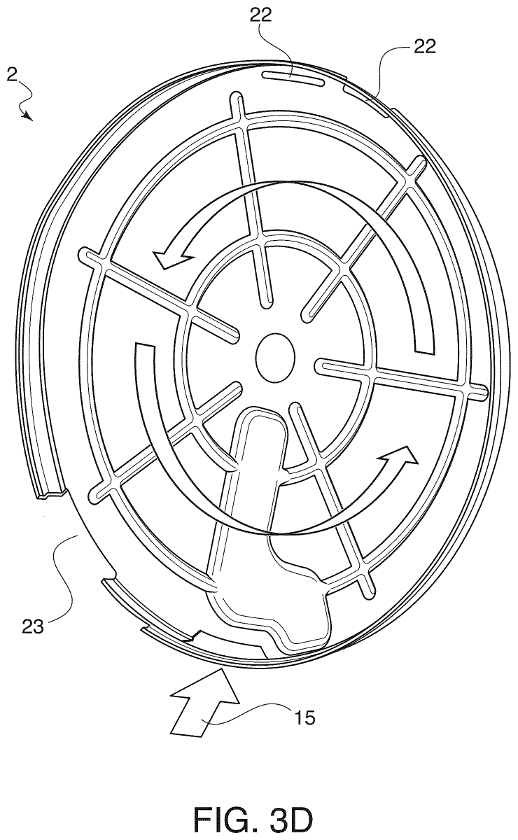

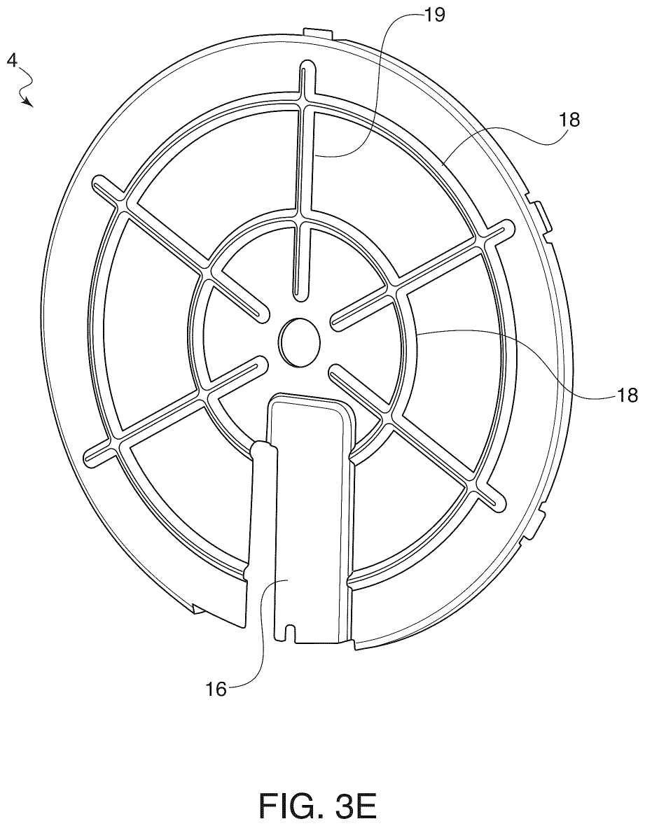

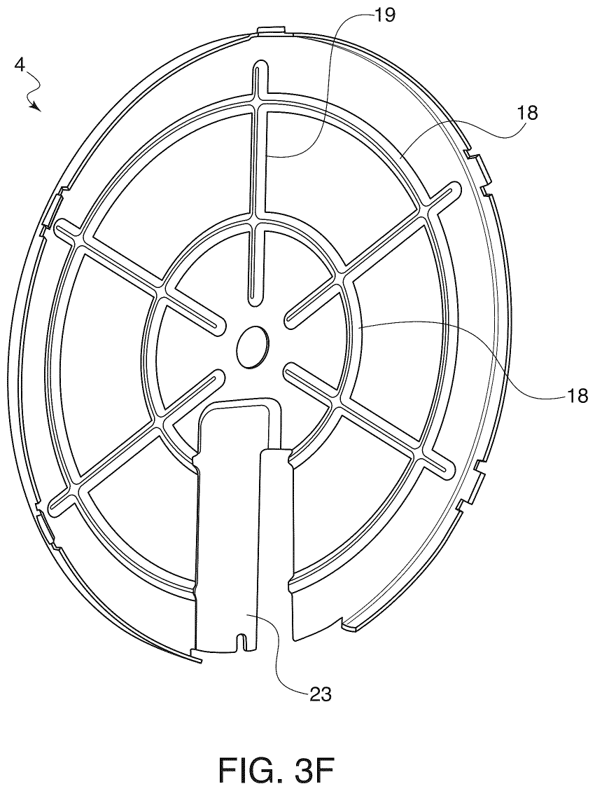

Referring to FIGS. 1 and 2, there is shown an exemplary label applicator machine 1 having the label roll cooling cover 10 in place. The cover 10 includes a cool air input connector 12, cool air manifolds 14 (and 16 shown in FIG. 3) and connected to each of the cool air manifolds are a series of cooling channels 18. In FIG. 3D, the arrows represent one example of the air flow inside the cooling cover.

In at least one embodiment, the cooling cover 10 is made of two sides 2 and 4 and operates as the label roll holder in addition to providing the cooling aspects of the present invention. The cover 10 includes air outputs 22 (FIGS. 3C and 3D) and 23, positioned on side 2 to allow the hot air to be exhausted from the cover during operation. As shown, in one exemplary embodiment, a slidable control or cover 20 can be provided over exhaust openings 22, 23 to control the output of air, and thus assist in the temperature control within the cover 10. In this example, a threaded knob 24 can be used to secure the slidable cover 20 in a desired position over the exhaust openings 22, 23.

In accordance with one implementation, the sides 2, 4 that make up the cover can be made of plastic, metal or any other sufficiently rigid material that can be formed and operate as disclosed herein.

Referring to FIGS. 3A-3F, the cooling cover 10 is generally made up of two sides, 2 and 4. Shown in FIGS. 3C and 3D, side 2 includes a cool air manifold 14 that is in air communication with the concentric channels 18 and radial channels 19 which are in communication with each other as shown. Side 2 also includes exhaust openings 22 near the top or circumferential edge thereof, and which are selectively opened/closed by the slidable control cover 20 mentioned above (shown in FIG. 1). In one implementation, an additional exhaust opening 23 (with an additional slidable control cover) can be included near the bottom or circumferential edge of side 2.

As shown in FIGS. 3E and 3F, side 4 includes a cool air manifold 16 positioned such that it is in direct air communication with the cool air input connector 12 that is positioned to receive the cool air intake 15. Manifold 16 extends from the perimeter radially toward the center of the cover 4. As will be evident, the cool air manifold 16 is connected to the concentric air channels 18, which themselves are connected to each other through radial air channels 19.

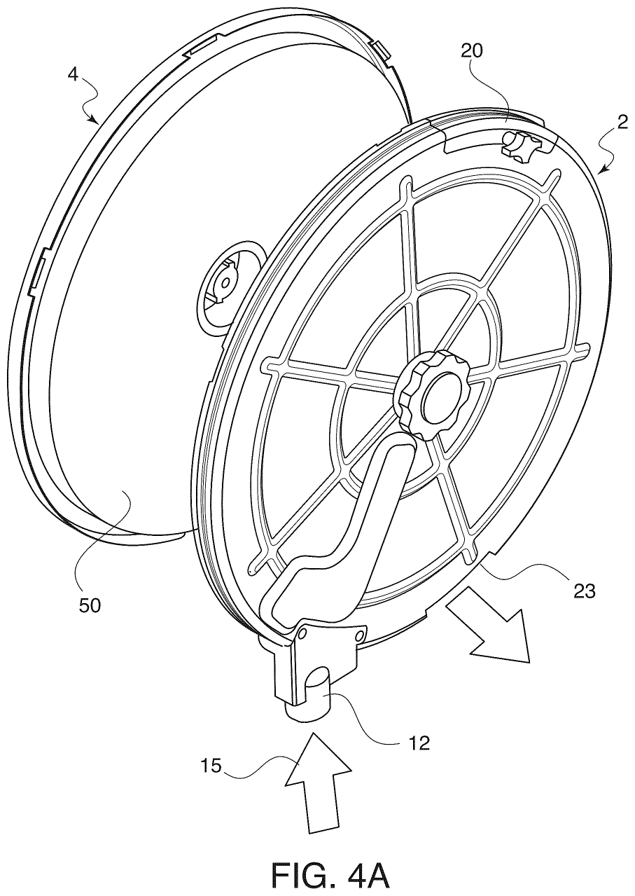

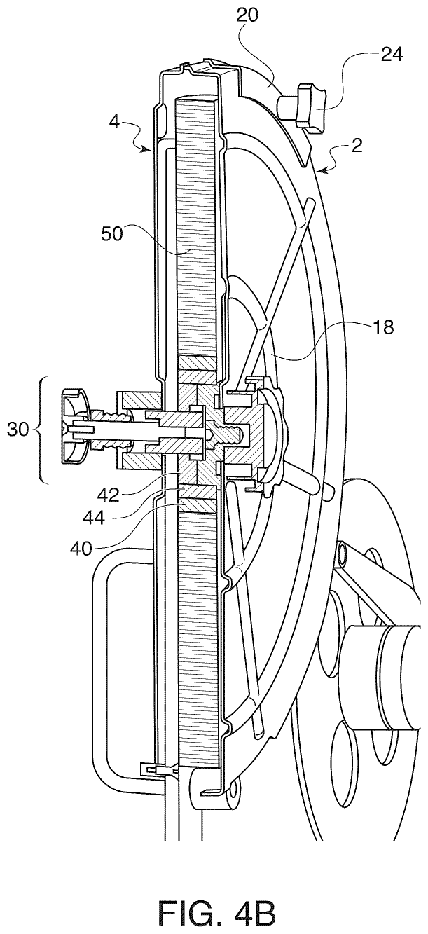

FIGS. 4A and 4B show one side 4 of the cover 10 holding the label roll 50 with the closing cover 2 positioned so as to fit over and attach to the other side 4 of the same. The connection mechanism 30 can include various parts including a tension knob, and shaft support that maintains the label roll 50 with the cover 10 positioned there-around. The connection mechanism connects the label roll (with cover) to the label dispensing machine such that once connected, the label roll can rotate within the cover 10 during operation while the cover is stationary and connected at connection point 12 to a cold air source 15. As will be appreciated, the label roll 50 has a core 40 at its center. The core 40 is held by a core holder 42 attached to one of the covers 2 or 4 (See FIGS. 4A, 4B). Over the core holder there is a free rotating adapter 44 that engages the core 40 of the label roll 50 and rotates freely around the core holder 42 of the cover.

In accordance with one embodiment, the cooling cover has the following features: 1) an external operating temperature of 70° F.-130° F.; 2) a desired internal temperature of 60° F., not to exceed 72° F. Those of skill in the art will appreciate that sensors can be included at the air input 12 and outputs 20 or even within the cover 10 to monitor and control the temperature within the cooling cover during operation. In one implementation, the temperature is monitored visually with a surface thermometer positioned inside one cover side, preferably the transparent cover side.

As noted above, the cooling air is input into the cooling cover via connection point 12. In one implementation, the cooled compressed air 15 travels in a Flex tubing and is received by the connection point 12. Those of skill in the art will appreciate that the source (i.e., cooling systems used) for the cool air input into the system and connected to the connection point 12 can take many different forms without departing from the intended scope of the invention. One example could be a portable air conditioner with its output configured into a distribution manifold that could feed one or more of the cooling covers of the present invention. In another example, the source of the cold air 15 could be a compressed air system with and/or without Vortex cooling.

In accordance with other aspects of the invention, each labeling system can typically have anywhere from 2 to 20 covers per system.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles.

Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, parameters, thresholds, and other elements used herein are provided as examples, and can be given a different name or label. The use of the term “or” is not limited to exclusive “or” but can also mean “and/or”.

What is claimed is:

1. A label roll cooling cover comprising:
a first side and a second side, the first and second sides configured to fit around a label roll;
a plurality of air channels disposed on an inside surface of at least one of the first side and second side;
a cool air input on at least one of the first side or second side, the air input in communication with the plurality of air channels; and
at least one exhaust air output positioned at an edge of at least one of the first side and second side.

2. The label roll cooling cover according to claim 1, further comprising a connection mechanism configured to connect the first side and second side together with a label roll rotatably disposed between the two sides, the connection mechanism enabling the label roll with cooling cover to be attached to a label dispensing machine.

3. The label roll cooling cover according to claim 1, further comprising at least one air manifold integrated into at least one of the first side or second side, the at least one air manifold in air communication with the cool air input and the plurality of air channels.

4. The label roll cooling cover according to claim 1, further comprising at least one exhaust adjustment device positioned over the at least one exhaust air output, the at least one exhaust adjustment device enabling adjustment of a rate of the exhaust air output and thereby enabling control of a temperature within the cooling cover.

5. The label roll cooling cover according to claim 1, further comprising a cool air source connected to the cool air input.

6. The label roll cooling cover according to claim 5, wherein the cool air source comprises a portable air conditioner.

7. The label roll cooling cover according to claim 5, wherein the cool air source comprises a compressed air system.

8. The label roll cooling cover according to claim 4, further comprising a cool air source connected to the cool air input, the cool air source operating in conjunction with the at least one exhaust adjustment device to maintain a temperature inside the cooling cover in a range of 60° F.-72° F.

9. The label roll cooling cover according to claim 2, wherein the connection mechanism comprises a core holder and a free rotating adapter positioned over the core holder.

10. The label roll cooling cover according to claim 7, wherein the compressed air system includes Vortex cooling.

11. A label roll cooling cover comprising:
a first side and a second side, the first and second sides configured to fit around a label roll;
a plurality of air channels disposed on an inside surface of at least one of the first side and second side; and
a connection mechanism connecting the first side to the second side with the label roll disposed therein, the connection mechanism comprising a core holder and a free rotating adapter positioned over the core holder enabling the label roll with cooling cover to be attached to a label dispensing machine.

12. The label roll cooling cover according to claim 11, further comprising:
a cool air input on at least one of the first side or second side, the air input in communication with the plurality of air channels; and
at least one exhaust air output positioned at an edge of at least one of the first side and second side.

13. The label roll cooling cover according to claim 12, further comprising at least one air manifold integrated into at least one of the first side or second side, the at least one air manifold in air communication with the cool air input and the plurality of air channels.

14. The label roll cooling cover according to claim 12, further comprising at least one exhaust adjustment device positioned over the at least one exhaust air output, the at least one exhaust adjustment device enabling adjustment of a rate of the exhaust air output and thereby enabling control of a temperature within the cooling cover.

15. The label roll cooling cover according to claim 12, further comprising a cool air source connected to the cool air input.

16. The label roll cooling cover according to claim 15, wherein the cool air source comprises a portable air conditioner.

17. The label roll cooling cover according to claim 15, wherein the cool air source comprises a compressed air system.

18. The label roll cooling cover according to claim 12, further comprising a cool air source connected to the cool air input, the cool air source operating in conjunction with the at least one exhaust adjustment device to maintain a temperature inside the cooling cover in a range of 60° F.-72° F.
